(19) United States
(12) Patent Application Publication
(10) Pub. No.: US 2024/0253145 A1
(43) Pub. Date: Aug. 1, 2024

(54) GEOLOGIC MATERIAL REMOVAL SYSTEM

(71) Applicant: EarthGrid PBC, Richmond, CA (US)

(72) Inventors: Troy Anthony Helming, Oakland, CA (US); Gregory Scott Lane, Berkeley, CA (US); Miles L. Downing, Vancouver, WA (US); Michelle Temple, Richmond, CA (US); Carmelo Fruci, Desert Hot Springs, CA (US); Jeffrey O. Irvine, Bethel Island, CA (US); Jeffrey Allen Dzado, Port Orchard, WA (US); David Alspaugh, Seattle, WA (US); Tylee Harvison, New Iberia, LA (US); Brian Kretsch, Alamo, CA (US); Brian Lane, Richmond, CA (US); Sam Lane, Richmond, CA (US); Chad Propst, San Anselmo, CA (US)

(21) Appl. No.: 18/429,237

(22) Filed: Jan. 31, 2024

Related U.S. Application Data
(60) Provisional application No. 63/442,762, filed on Feb. 1, 2023.

(51) Int. Cl. B23K 10/00; B23K 37/00; E02F 3/38; B23K 103/00

(52) U.S. Cl. CPC B23K 10/006; B23K 10/003; B23K 37/003; E02F 3/38; B23K 2103/50

(57) ABSTRACT

A plasma excavation system comprising a moveable support structure including a controller, an attachment mechanism removably coupled to the moveable support structure, and a plasma torching head coupled to the attachment mechanism, the plasma torching head moveable along two axes.

### RELATED APPLICATIONS

The present application claims priority to U.S. Provisional Application No. 63/442,762, filed on Feb. 1, 2023, and incorporates that application in its entirety by references.

### FIELD

The present invention relates to material removal, and more particularly to using one or more plasma torches to remove geologic material.

### BACKGROUND

Trenching systems are used to dig trenches for laying utility pipes and other purposes. Modern trenching systems typically use a skid loader with a trenching attachment, or a trench digger. These tools generally use cutter teeth on a rotating chain, to cut through the ground and dig a trench. However, such trench digging tools are slow and difficult to maintain.

### BRIEF DESCRIPTION OF THE FIGURES

The present invention is illustrated by way of example, and not by way of limitation, in the figures of the accompanying drawings and in which like reference numerals refer to similar elements and in which:

FIG. 1A is a simplified diagram of one embodiment of a geologic material removal system.

FIG. 1B is an illustration of one embodiment of the plasma torching head on an excavator.

FIG. 1C is an illustration of the excavator of FIG. 1A, with the plasma torching head in a vertical orientation.

FIG. 1D is an illustration of one embodiment of the plasma torching head of FIG. 1A.

FIG. 1E illustrates one embodiment of the range of motion of the plasma torching head.

FIG. 1F illustrates an alternative embodiment of the plasma torching head coupled to the attachment mechanism.

FIG. 2A is an illustration of one embodiment of a baffle with a plasma torching head.

FIG. 2B is a side view of one embodiment of the baffle with the plasma torching head, with the baffle shown as transparent.

FIG. 2C is a front of one embodiment of the baffle with the plasma torching head, with the baffle shown as transparent.

FIG. 2D is an illustration of another embodiment of the baffle with a plasma torching head.

FIG. 2E is an illustration of another embodiment of the baffle with a plasma torching head.

FIG. 2F is an illustration of another embodiment of the baffle with a plasma torching head.

FIG. 3A is a diagram of one embodiment of the system.

FIG. 3B is a diagram of one embodiment of the plasma torching head.

FIG. 3C is a diagram of one embodiment of the front view of the plasma torching head.

FIG. 3D is a diagram of one embodiment of the front view of a three torch plasma torching head.

FIG. 3E illustrates an alternative embodiment of the plasma torching head 380.

FIG. 4A is a perspective illustration of one embodiment of the plasma torching head and attachment mechanism.

FIG. 4B is a side view illustration of one embodiment of the plasma torching head and attachment mechanism.

FIG. 4C is a front view illustration of one embodiment of the plasma torching head and attachment mechanism.

FIG. 4D is a back view illustration of one embodiment of the plasma torching head and attachment mechanism.

FIG. 5A is an illustration of one embodiment of the protective casing for the plasma torch.

FIG. 5B is an illustration of the interior of protective casing of FIG. 5A, with the casing shown as transparent.

FIGS. 5C-5D illustrate one embodiment of the torch extension adjuster.

FIG. 6 is an illustration of one embodiment of the air/water squid.

FIG. 7 is an illustration of one embodiment of the attachment mechanism.

FIG. 8A is an illustration of one embodiment of a vacuum head which may be used with the present system.

FIGS. 8B-8C are an illustration of one embodiment of a kiln which may be used with the present system.

FIGS. 9A-9C illustrate embodiments of the torch head, showing various numbers of torches.

FIG. 9D is a diagram of one embodiment of a torch arrangement for a vertical triple torch head.

FIG. 9E is a side view of the diagram of FIG. 9D, showing moveable outside torches.

FIGS. 9F-9G are diagrams of two exemplary multiple torch arrangements, with differing torch sizes.

FIG. 10A is a diagram showing one embodiment of the connections of the system.

FIG. 10B is a diagram showing another embodiment of the connections of the system.

FIG. 11 is a flowchart of one embodiment of using the geologic material removal system.

FIG. 12 is a flowchart of one embodiment of using the geologic material removal system with a moveable baffle.

### DETAILED DESCRIPTION

A geologic material removal system using one or more plasma torches is described. The geologic material removal system includes a moveable element, to which a plasma torching head is coupled. The plasma torching head in one embodiment is designed to move and can be used at a variety of angles between the horizontal and vertical settings, and can rotate, in one embodiment up to 360 degrees. In one embodiment, the plasma torching head has six degrees of freedom. In one embodiment, the moveable element is a mechanical arm coupled to an excavator or other heavy equipment. In another embodiment, the mechanical arm may be attached to a tractor or other device.

In one embodiment, the plasma torching head may be used with a baffle. A baffle is a partial or complete enclosure designed to control the dispersion of the spoils from the removal of material. The baffle may include rails along which the plasma torching head can be moved. The plasma torching head may also move up and down within the baffle, changing the offset distance between the plasma torch and the geologic material.

The plasma torching head in one embodiment includes one or more plasma torches. Each plasma torch in the plasma torching head in one embodiment is surrounded by a protective casing. In one embodiment, protective rods extend along part or the entirety of the plasma torch. The protective rods in one embodiment are designed to crush in the event of an impact on the torch and are designed to be field replaceable. They are also used to guide the flow of air/water to the surface being removed, in one embodiment.

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized, and that logical, mechanical, electrical, functional, and other changes may be made without departing from the scope of the present invention. The following detailed description is, therefore, not to be taken in a limiting sense, and the scope of the present invention is defined only by the appended claims.

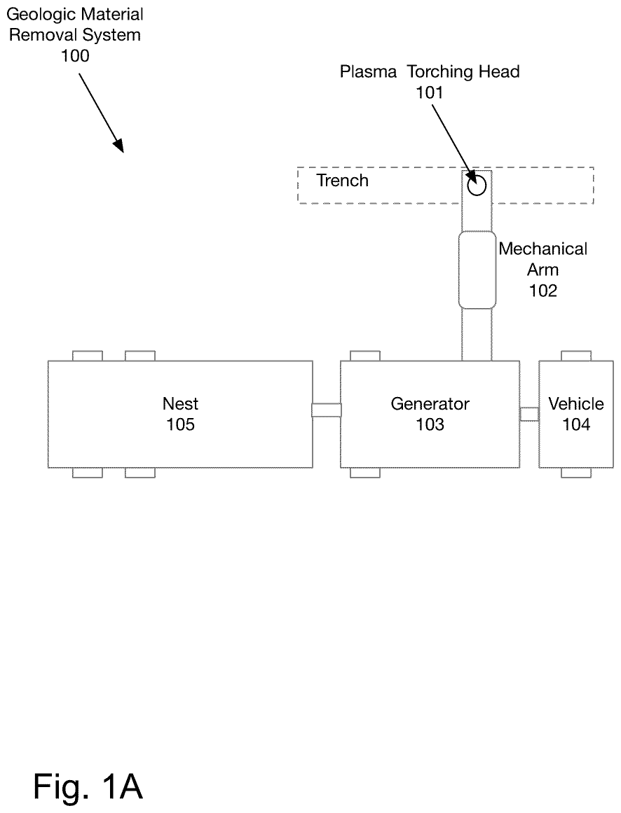

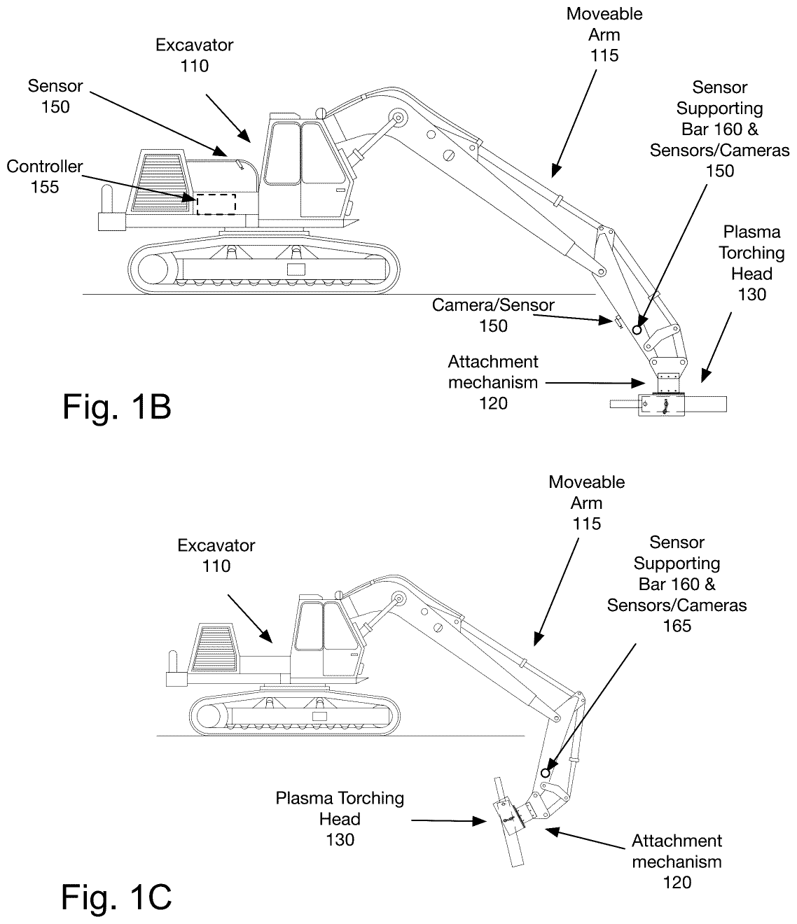

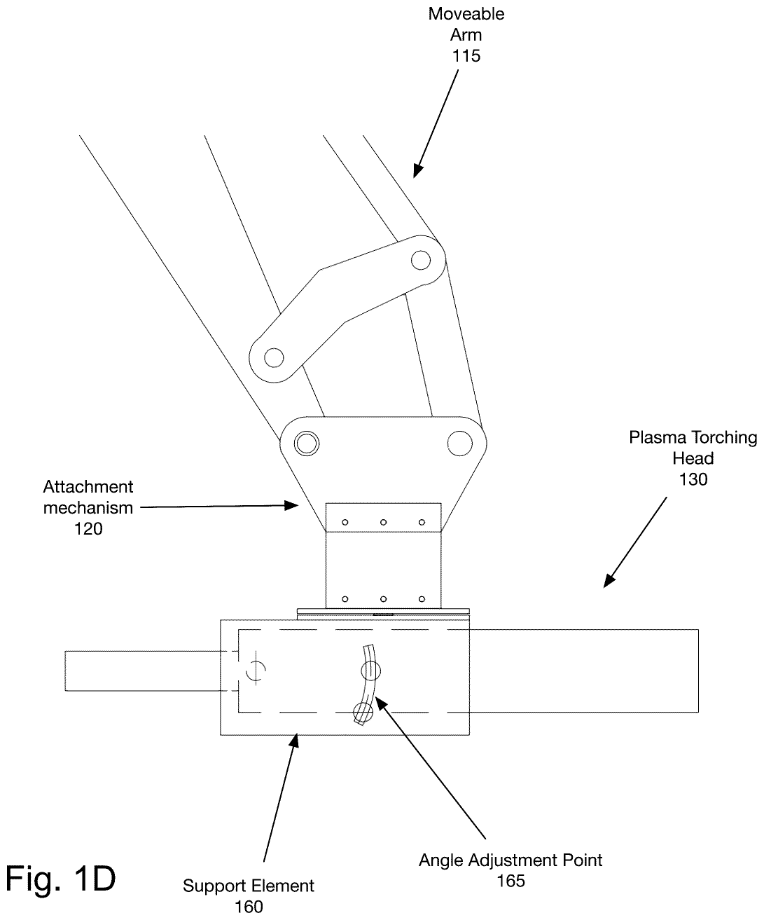

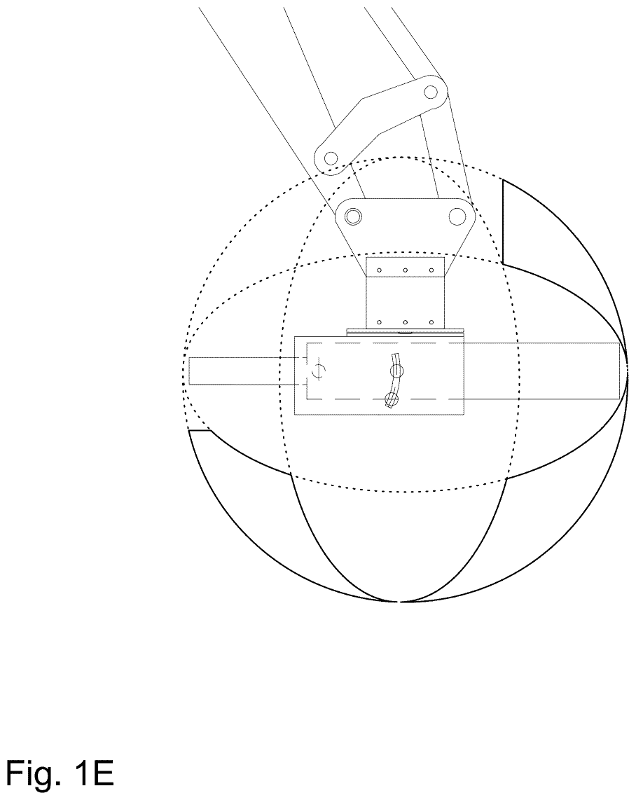

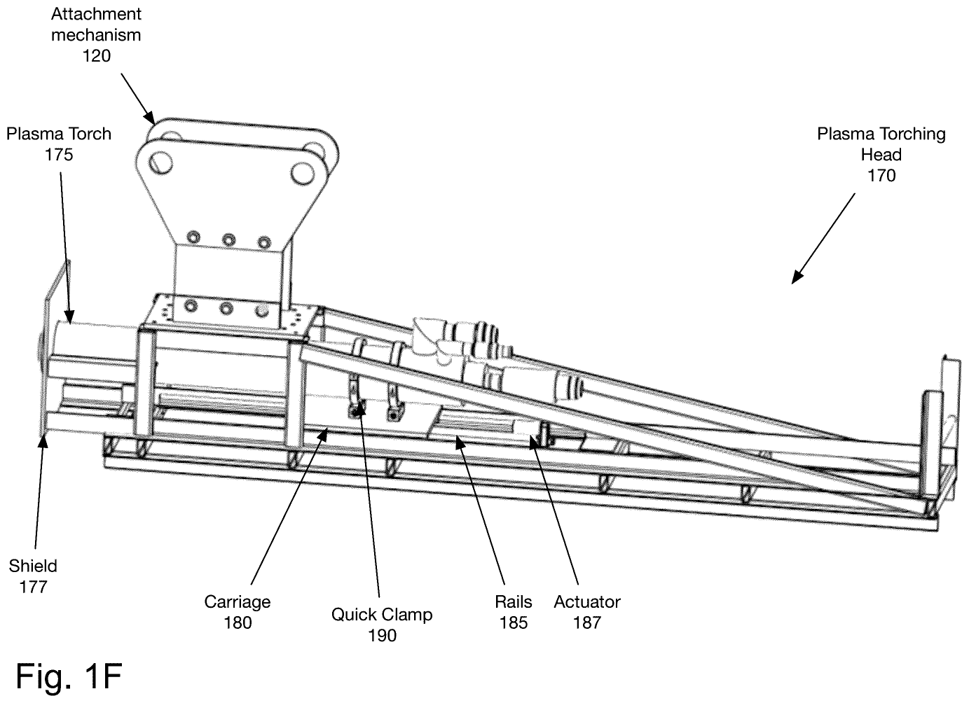

FIG. 1A is a simplified diagram of one embodiment of a geologic material removal system. The geologic material removal system 100 is designed to remove material using one or more plasma torches in order to excavate a trench, tunnel, or other structure. The term geologic material refers to soil, earth, rock, metals, and other materials which make up the earth. In one embodiment, geologic material may also include man-made materials, including cement. The removal of such material is through destruction, breaking up, spallation, melting, and physical removal.

The system 100 supports a plasma torching head 101, which in this illustration is removing material to create a trench. The plasma torching head 101 may include one or more plasma torches. The plasma torches may be various sizes/power levels. In one embodiment, the plasma torch power may range between 100 KW and 10 MW. However, other power levels may be used as well.

The mechanical arm 102 provides multiple degrees of freedom, so the plasma plume can be positioned at a variety of angles, depths, and positions. In one embodiment, the mechanical arm 102 in combination with the plasma torching head 101 and the vehicle 104 provide the full six degrees of freedom. The mechanical arm 102 is supported by the generator 103. The generator provides power for the plasma torching head 101, as well as cold water/air for cooling the plasma torch and optionally the geologic material, to increase the effectiveness of the plasma torch. The nest 105 in one embodiment has the remaining plant equipment. This may include one or more of power supplies, transformers, chillers, air compressors, pumps, motors, and/or processors providing control signals and sensor data analysis. The vehicle portion 104 is designed to move the entire system 100 including the generator, nest, and mechanical arm. The configuration illustrated, with a separate nest 105, generator 103, and vehicle 104 is merely an exemplary embodiment. Other configurations may integrate these elements into a single system or separate them further into additional elements that are not directly interconnected.

FIG. 1B is an illustration of one embodiment of the plasma torching head on an excavator. In this example, the plasma torching head 130 is coupled to the moveable arm 115 of the excavator 110. The attachment mechanism 120 in one embodiment provides movement around the Y axis, while the moveable arm 115 provides movement in the X and Z directions. In one embodiment, the attachment mechanism 120 also provides some movement around the X axis, allowing the plasma torching head 130 to rotate downward.

In addition, the excavator 110 provides locations for a plurality of sensors and/or cameras 150. In one embodiment, a sensor supporting bar 160 extends from the moveable arm 115, to provide positioning for one or more sensors and/or cameras 150. In addition, in one embodiment, additional cameras/sensors 150 may be coupled to the moveable arm 115, and/or the plasma torching head 130. The sensors/cameras 150 are positioned to be able to sense the area where material is being removed, without being damaged by the high heat plasma plume, the spoils, steam, or water. In one embodiment, some sensors may be hardened sensors located on or in closer proximity to the plasma torching head 130. The sensors may include, for example, cameras with and without fisheye lenses, infrared sensors, temperature sensors, ground penetrating radar, LIDAR, SONAR, gas sensors to identify the presence of dangerous gases, gas sensors to determine the mineralogy of the rock or material being removed, molecular scanners for mineralogy, moisture sensors, humidity sensors, and other sensors. In one embodiment, some or all of these sensors may be located within the excavator or other portions of the system. In one embodiment, the sensors/cameras 1505 may be wirelessly coupled to an analysis system (not shown). In another embodiment, the sensors/cameras 150 may be coupled via a cable or other connection. In one embodiment, there may be receiver station which receives data from the sensors/cameras 150. In one embodiment, processing of sensor/camera data may be done by a processor in the excavator 110 and/or remotely at a server.

The excavator 110 in one embodiment also provides supplies for the plasma torching head 130, which may include power and cooling for the plasma torch, water and/or air for cooling the area where material is being removed. Additionally, the excavator 110, or a controller 155 positioned within the excavator provides the settings for the plasma torching head, analysis of the sensor data, and feedback to users and the plasma torching head 130. In one embodiment, the controller 155 may include local processors or computing systems, and/or processors and computing systems accessed via a network, and remote from the site. Additionally, the excavator 110 may include a global positioning system (GPS), gyroscopes, accelerometers, and/or other navigational sensors. In one embodiment, the controller 155 system may receive mapping data, showing the presence of existing underground structures. In one embodiment, some of the sensors may be used to identify such structures, and they may be added to the map by the controller 155.

FIG. 1C is an illustration of the excavator of FIG. 1A, with the plasma torching head 130 in a near-vertical orientation. In one embodiment, the moveable arm 115 can position the plasma torching head 130, and the attachment mechanism 120 also provides further positioning capabilities. In one embodiment, the movement of the plasma torching head 130 is restricted so that the plasma plume cannot extend toward the excavator 110 or support structure.

FIG. 1D is another illustration of one embodiment of the plasma torching head 130 of FIG. 1A. The attachment mechanism 120 includes an attachment to the moveable arm 115, and a support element 160 to which the plasma torching head 130 is coupled. The support element 160 in one embodiment includes an angle adjustment point 165 allowing the plasma torching head to rotate downward and upward. In one embodiment, the angle adjustment point 165 limits movement of the plasma torching head 130 to ensure the plasma plume cannot hit the moveable arm 115 or the support structure. In one embodiment, the angle adjustment is controlled via a motor, actuator, or other mechanism (not shown). In one embodiment, the controller 155 controls the moveable arm 115 and attachment mechanism 120 to position the plasma torching head 130 at a selected angle. In one embodiment, that angle may range from the horizontal (as shown) to vertical. In one embodiment, the attachment mechanism may also permit the plasma torching head 130 to be moved from side to side. FIG. 1E illustrates one embodiment of the range of motion of the plasma torching head. In one embodiment, plasma torching head 130 movement may be 360 degrees around the Y-axis, as well as 90 to 270 degrees around the X-axis.

FIG. 1E illustrates an alternative embodiment of the plasma torching head 170, coupled to the attachment mechanism 120. The attachment mechanism 120 is coupled to mechanical arm. The plasma torch 175 is coupled to a carriage 180. In one embodiment, the coupling uses quick clamps 190, enabling the plasma torch 175 to be removed and replaced, as needed. The carriage 180 can move along rails 185, to change the offset of the plasma torch 175 from the material being removed. The carriage 180 is moved by an actuator 187 in one embodiment. In one embodiment, there is a shield 177 at the front of the plasma torching head 170, through which the plasma torch extends. In one embodiment, the shield provides protection to the plasma torching head 170, and reflects the heat from the plasma torch 175, to improve cutting efficiency and protect the plasma torching head.

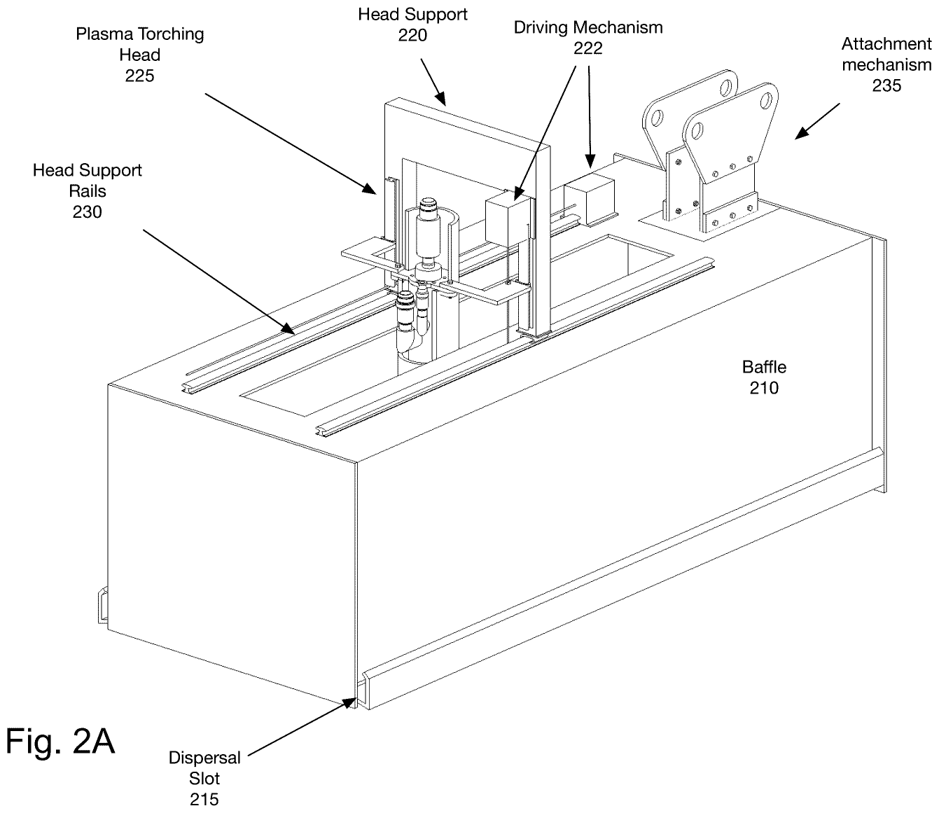

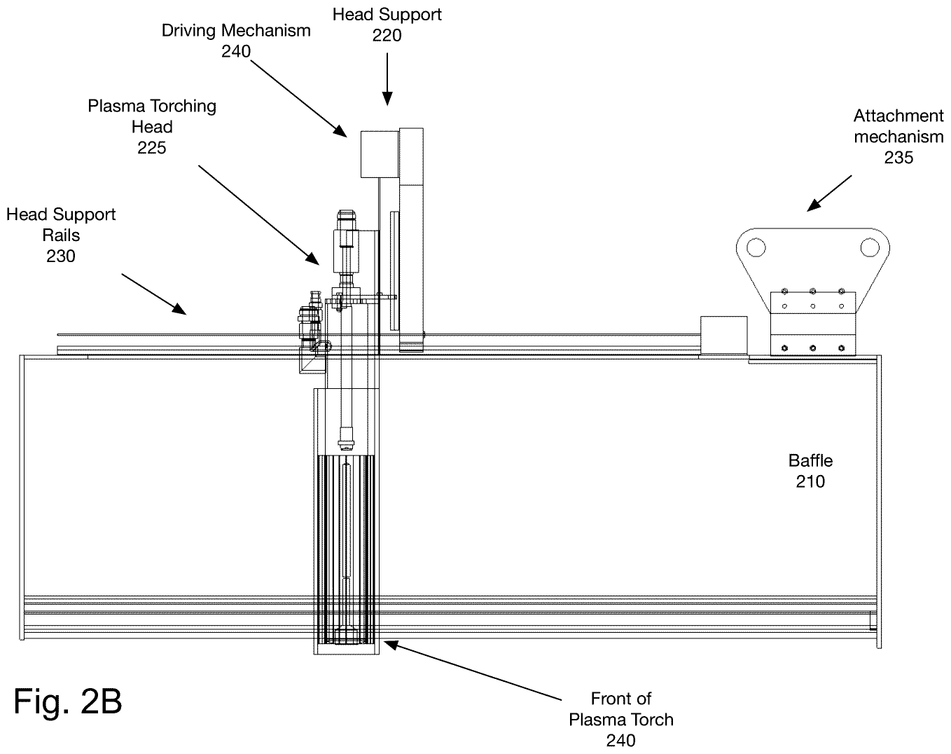

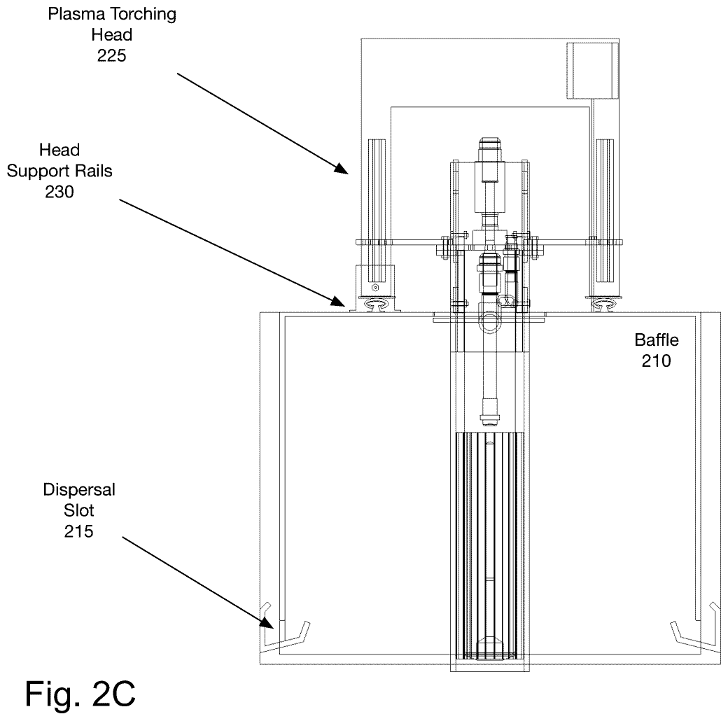

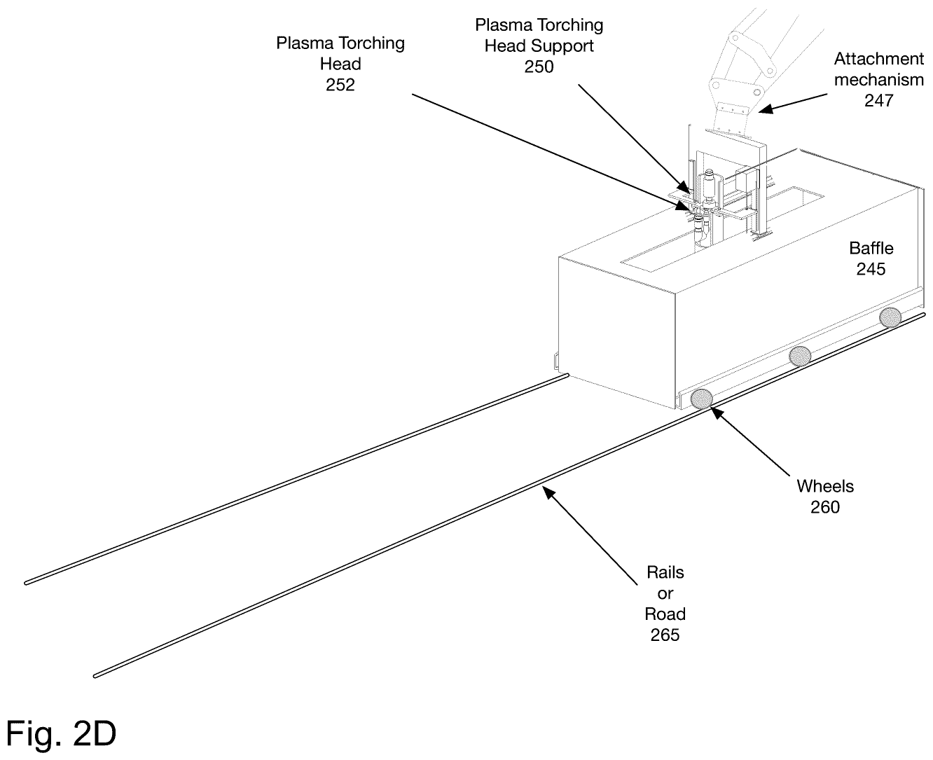

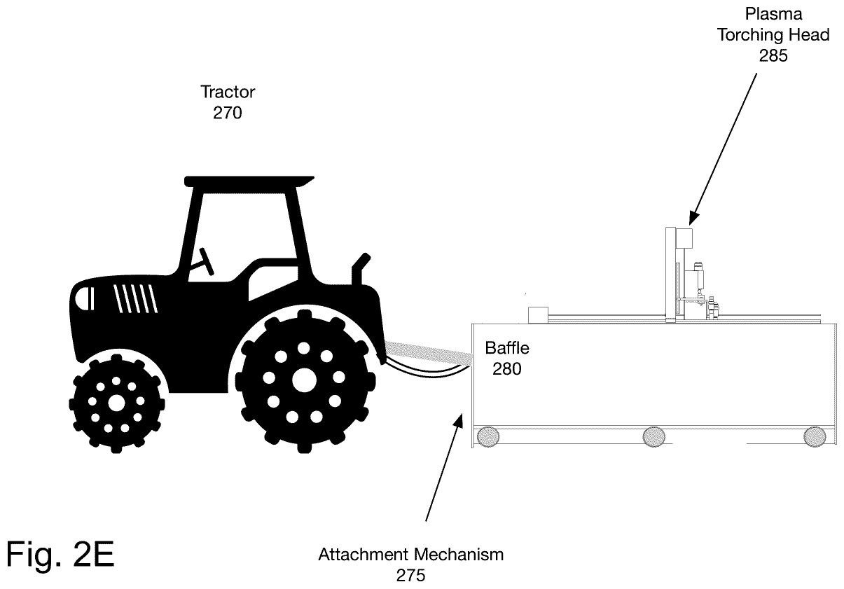

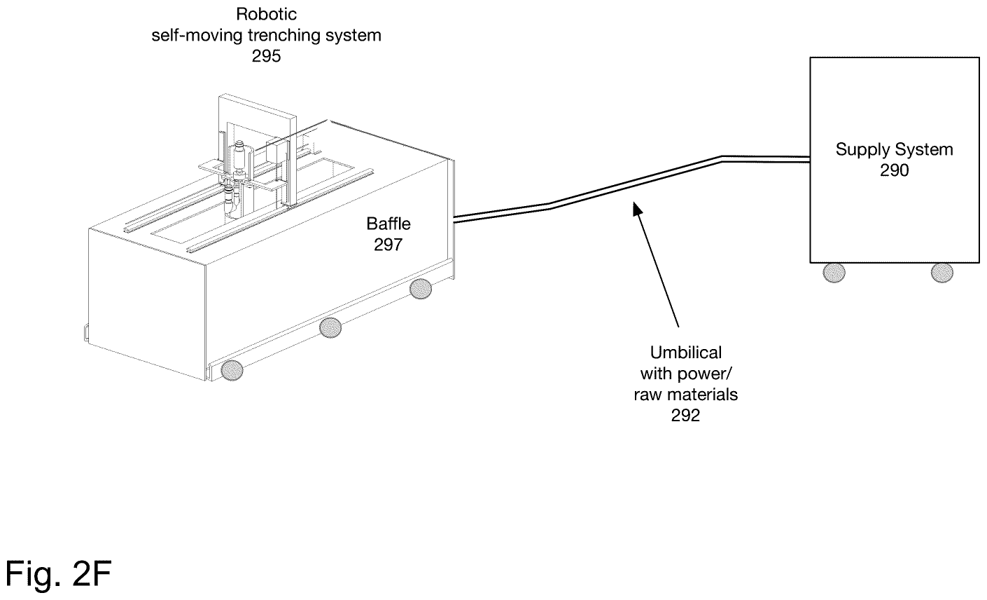

FIG. 2A is an illustration of one embodiment of a baffle with a plasma torching head. The baffle 210 keeps the spoils contained. In this configuration, the attachment mechanism 235, which is used to couple the system to an excavator, is coupled to a baffle 210. The baffle contains the spoils generated by the plasma torches. In one embodiment, a dispersal slot 215 allows the spoils to escape the baffle 210. In one embodiment, the plasma torching head 225 is pointed downward, and moves along head support rails 230. In one embodiment, driving mechanisms 222 move the plasma torching head 225 along the rails 230 and up or down along head support 220. The plasma torching head 225 may move upward and downward within head support 220, to alter the offset between the plasma torch and the ground.

This configuration of the system is designed to have the baffle 210 placed in a first position, and then the plasma torch head moving along the rails 230, potentially repeatedly, to remove material to the appropriate depth. The baffle 210 is then moved to the next position, to continue removing material.

FIG. 2B is a side view of one embodiment of the baffle with the plasma torching head, with the baffle shown as transparent. In this configuration, as can be seen, the front of the plasma torch 240 extends below the bottom of the baffle. The plasma torching head support 220 allows upward and downward motion of the plasma torch 240. In one embodiment, as more material is removed, the plasma torch 225 is moved downward. As discussed above, the controller sets the offset between the front of the plasma torch 240 and the ground. This distance may be set based on the depth of the material for removal, and the geologic material composition.

FIG. 2C is a front of one embodiment of the baffle with the plasma torching head, with the baffle shown as transparent. One embodiment of the dispersal slot 215 can be seen. As the plasma plume breaks through the ground, the spoils may be flung upward, and may exit the baffle 210 through dispersal slots 215. However, the majority of the spoils are handled by a vacuum system, described below.

FIG. 2D is an illustration of another embodiment of the baffle with a plasma torching head. In this configuration, the attachment mechanism 247 is coupled to the plasma torching head support 250. The plasma torching head can move up and down in this configuration but does not move along the baffle 245. Thus, the mechanical arm moves the plasma torching head 252, and the baffle 245 along with it. The baffle 245 moves along rails or a road with wheels 260 or another mechanism for locomotion. This configuration of the system is designed to have the baffle 245 placed in a first position, and then the baffle and plasma torching head moving along the rails 265, potentially repeatedly, to remove material to the appropriate depth, with the horizontal movement of the plasma torching head 252 controlled by the mechanical arm directly, via attachment mechanism 247.

FIG. 2E is an illustration of another embodiment of the baffle with a plasma torching head. In this configuration, the baffle 280 is pulled by a tractor 270 or other powered system using wheels or another mechanism allowing movement. In one embodiment, the plasma torching head 285 moves along the rails of the baffle 280. In another embodiment, the plasma torching head 285 may be stationary within the baffle, moving only up and down, and the horizontal movement may be provided by the tractor 270 pulling the baffle 280. The attachment mechanism 275 in this embodiment is to the baffle 280. This configuration of the system is designed to have the baffle 280 placed in a first position, and then the plasma torch head moving along the rails, potentially repeatedly, to remove material to the appropriate depth. The baffle 280 is then moved to the next position, to continue removing material.

FIG. 2F is an illustration of another embodiment of the baffle with a plasma torching head. In this configuration, the baffle 297 is part of a robotic self-moving system 295. The system 295 positions the baffle 297 and can move the baffle along using a road or rails, or other mechanism. In one embodiment, the power/water, and other supplies for the system 295 may be provided by a separate supply system 290. In one embodiment, the supplies are provided to the robotic system 295 via an umbilical connection 292 between the supply system 290 and the robotic self-moving system 295. In another embodiment, the robotic self-moving system 295 may be a single integrated system. In one embodiment, such an integrated system may have a connection to an external stationary supply system 290, for water/power/resources/control systems.

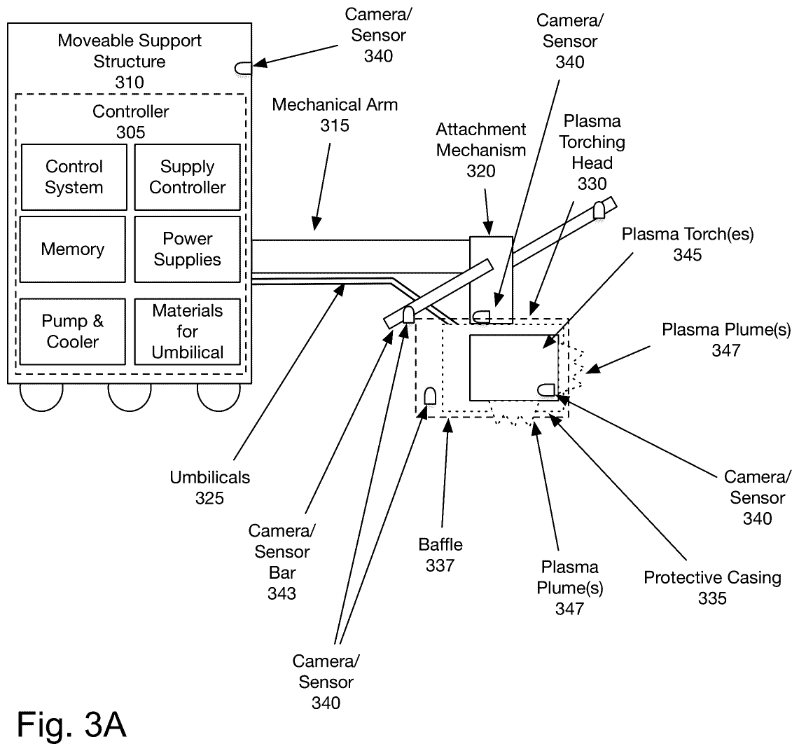

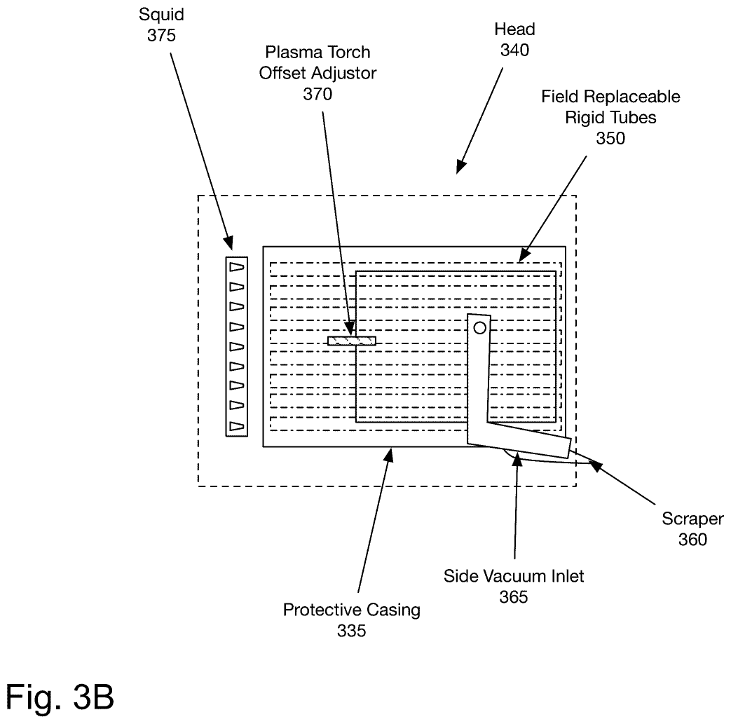

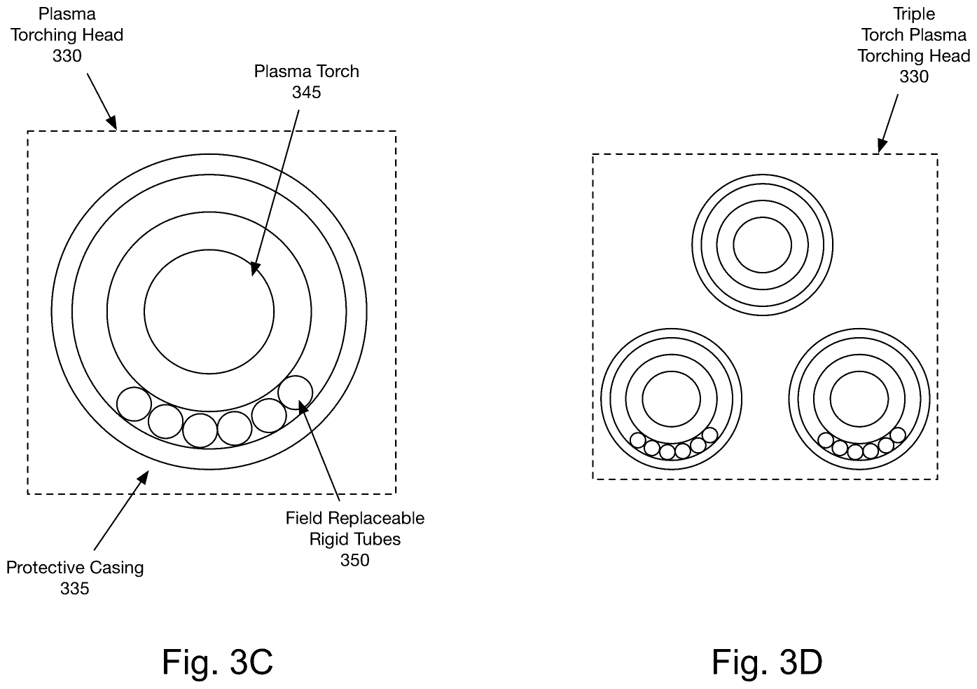

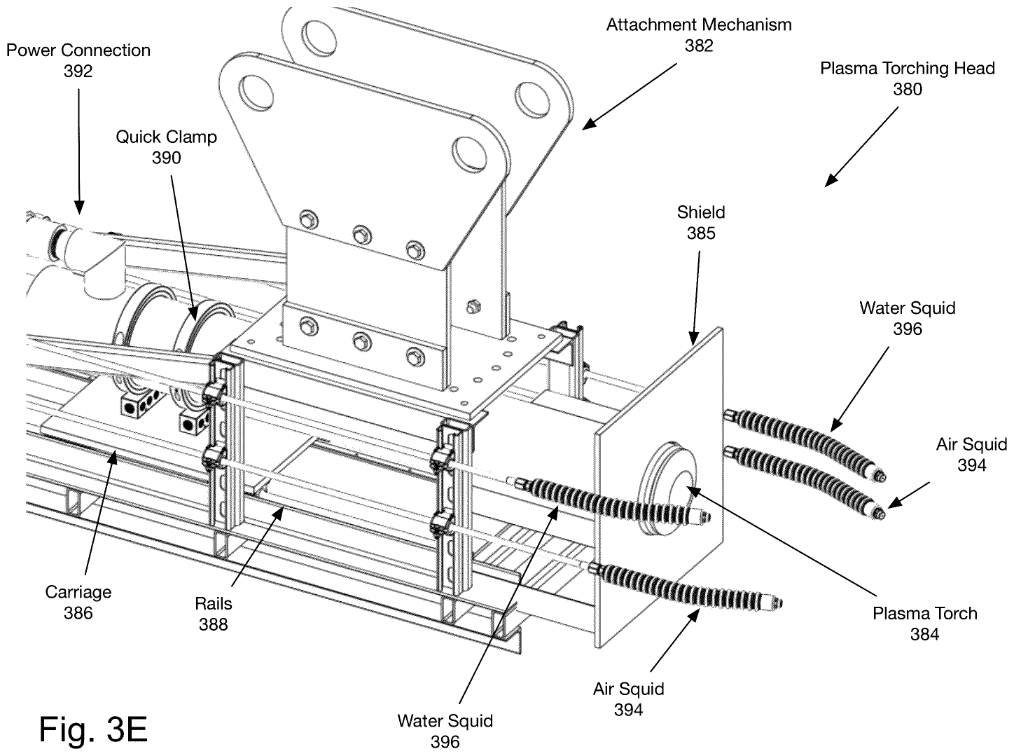

FIG. 3A is a block diagram of one embodiment of the system. The moveable support structure 310 in one embodiment may be any system that provides power and materials for the system. As shown above, the support structure 310 may be in some embodiments a combination of one or more of an excavator, a tractor, or another type of vehicle, and/or a baffle. In one embodiment, the controller 305 may include a control system such as computer system to analyze data from the cameras and sensors and control the settings of the system. The controller 305 may include a memory and/or buffer, to store the control software and status data, as well as sensor data. In one embodiment, memory may also include a local area map, that provides information about existing underground piping and wiring, to ensure that the system does not damage existing infrastructure. Supply controller controls the output from power supplies, and material for umbilical which includes water and other materials sent to the plasma torching head 330.

In one embodiment, control system, supply controller, and memory may be remote from the moveable support structure and coupled to the moveable support structure 310 via a network connection. In one embodiment, the moveable support structure 310 may include some of the control system elements, and analytics may be on a remote system.

The power supplies provide power to the plasma torches, as well as to the pumps and other powered elements in one embodiment. Pump and cooler are used to provide cold water and/or air to cool the plasma torches. In one embodiment, the pump and optionally cooler are used to direct jets of water and/or air onto the ground to assist with spalling the rock. The temperature difference between the cooling jet and the heat of the plasma plumes assists in breaking up the rock.

The moveable support structure 310 in one embodiment includes a mechanical arm 315 which moves the plasma torching head 330. In one embodiment, the mechanical arm 315 is the arm of an excavator. In another embodiment, the mechanical arm 315 may be any structure providing multiple degrees of freedom, to which the plasma torching head may be coupled. In another embodiment, the mechanical arm may be replaced by the head support rails and head support of a baffle.

The attachment mechanism 320 couples the plasma torching head 330 to the mechanical arm 315. Umbilical connections 325 provide supplies to the plasma torch(es), including water and/or other materials for cooling, and power. Umbilicals 325 also provide data from sensors to the controller 305, in one embodiment.

In one embodiment, camera/sensor bar 343 extends on either side of the plasma torching head 330 and provides a location for one or more cameras and/or sensors 340. In one embodiment, the relative positions of the cameras/sensors 340 is based on their ability to withstand the high temperatures generated by the plasma torches 345. In one embodiment, the camera/sensor 340 may be limited to the camera/sensor bar 343, the moveable support structure 310. In another embodiment, there may be camera/sensor elements 340 outside the baffle 337 or inside the baffle 337. The baffle 337 in one embodiment, is an enclosure for the plasma torches 345 which provides protection for the torches and protection from flying rocks or other particulate matter.

In one embodiment, in addition to the baffle 337, the plasma torches 345 are further protected by a protective casing 335. The protective casing 335 in one embodiment is a metal enclosure designed to protect the plasma torch. In another embodiment, the protective casing 335 may be made of other materials. In one embodiment, each plasma torch has a separate protective casing 335. In one embodiment, the protective casing 335 also maintains the heat reducing heat dispersal.

As shown in FIG. 3A, in one embodiment, the plasma plume 347 extends horizontally, and in a different embodiment, the plasma plume extends vertically from the plasma torching head 330. A configuration in which the plasma plume points forward may be more useful for some trenching applications or tunneling applications. The present design may be used for tunneling, trenching, boring holes, etc. In one embodiment, the angle of the plasma plume 347 may be rotated to any angle between horizontal and vertical. In one embodiment, the angle may point upward as well.

FIG. 3B is a diagram of one embodiment of the plasma torching head. The diagram illustrates the head 340 shown as transparent and does not show the plasma torches enclosed within the head. In one embodiment, the protective casing 335 comprises a set of field replaceable tubes 350, surrounding some or all of the plasma torch. The tubes 350 are designed to protect the plasma torch from impact or damage. In one embodiment, the tubes 350 can also be used to provide mechanical force to the removal of material. The tubes 350 in one embodiment can be used to scrape the material reduced by the plasma torch.

In addition, in one embodiment, the head 340 may include a side vacuum inlet 365, which is designed to vacuum up the spoils from the plasma torch. The spoils, in one embodiment, include small stones from spalling, as well as molten rock, and other material. In one embodiment, the vacuum inlet 365 includes a cooling mechanism, to rapidly reduce the temperature of the material being vacuumed, so that the umbilical hoses are not damaged. In one embodiment, at the end of the vacuum inlet there is a scraper 360, which may also be used to provide mechanical force for the removal of material.

The head 340 in one embodiment also includes a squid 375, which provides cooling to the material which is being removed. In one embodiment, the squid 375 sprays intermittent cooled water, mist, or air onto the material that the plasma torches are removing. In one embodiment, the plasma torch offset adjustor 370 permits the movement of the plasma torch within the head 340, to alter the offset and position the plasma torch for optimal cutting.

FIG. 3C is a diagram of one embodiment of the front view of the plasma torching head. The front shows the plasma torch 345, and some field replaceable tubes 350. In one embodiment, the tubes are made of copper, and are designed to be easily removed and replaced without the use of specialized tools. In this embodiment, the field replaceable tubes 350 extend only along a portion of the circumference of the plasma torch. In some embodiments, the tubes 350 may encircle the plasma torch completely. In one embodiment, these tubes 350 are designed to protect the plasma torch against damage by spoils. In one embodiment, the tubes may also be used to scrape the material that has been impacted by the plasma plume, but that has not completely disintegrated. The rocks and ground become more friable after impact, and can be scraped away using these tubes, in one embodiment. Furthermore, the tubes may be used to lead the water and/or air to cool the ground. In one embodiment, water mixed with air, in a mist form, is used to spray the geologic materials where the plasma torches work. In some embodiments, as shown in FIG. 3D, the tubes surround only the plasma torches which are closest to the ground.

FIG. 3E illustrates an alternative embodiment of the plasma torching head 380. The plasma torching head is coupled to the moveable support structure using attachment mechanism 382. Because this structure does not utilize a protective shell around the plasma torch, it allows for narrower penetration areas, as the torch advances through the shield. The plasma torch 384 is coupled to a carriage 386 using quick clamps 390, in one embodiment. The quick clamps in one embodiment are two piece collars allowing the plasma torch to be removed and replaced quickly. The carriage 386 can move forward and backward along rails 388, to move the head of the plasma torch 384, and alter the offset between the plasma torch and the material being removed.

In one embodiment, the plasma torching head 380 further includes squids 394, 396 which provide air and/or water to the area being worked. In one embodiment, the head 380 includes 1-4 lines for air, using an air squid 394, and 1-4 lines for water, using water squid 396. In one embodiment, the squids 394, 396 are flexible. In one embodiment, the squids 394, 396 can be positioned differently for different types of rock surfaces. In one embodiment, the output of the squids 394, 396 is computer controlled to provide a pulsed water and/or air at the torch/material interface, for cooling and spalling. In one embodiment, the output of the squids 394, 396 may be manually controlled.

In one embodiment, the length of the head 380 provides support for the hoses and umbilicals providing power to the plasma torch, movement mechanism, squids, and other portions of the head.

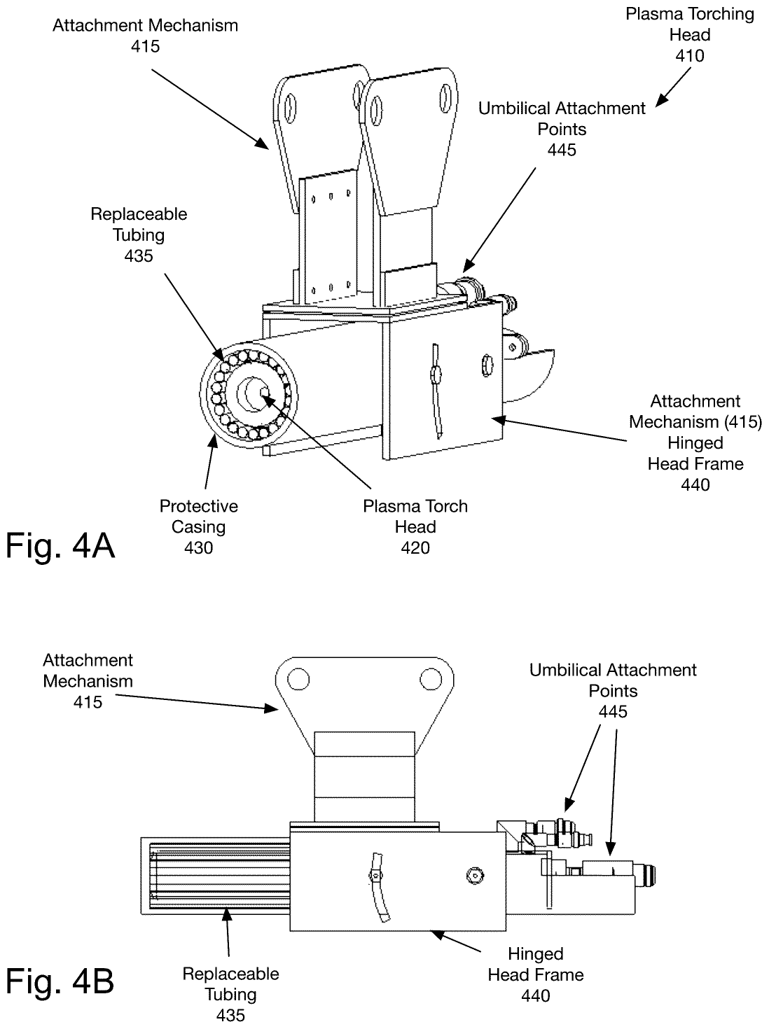

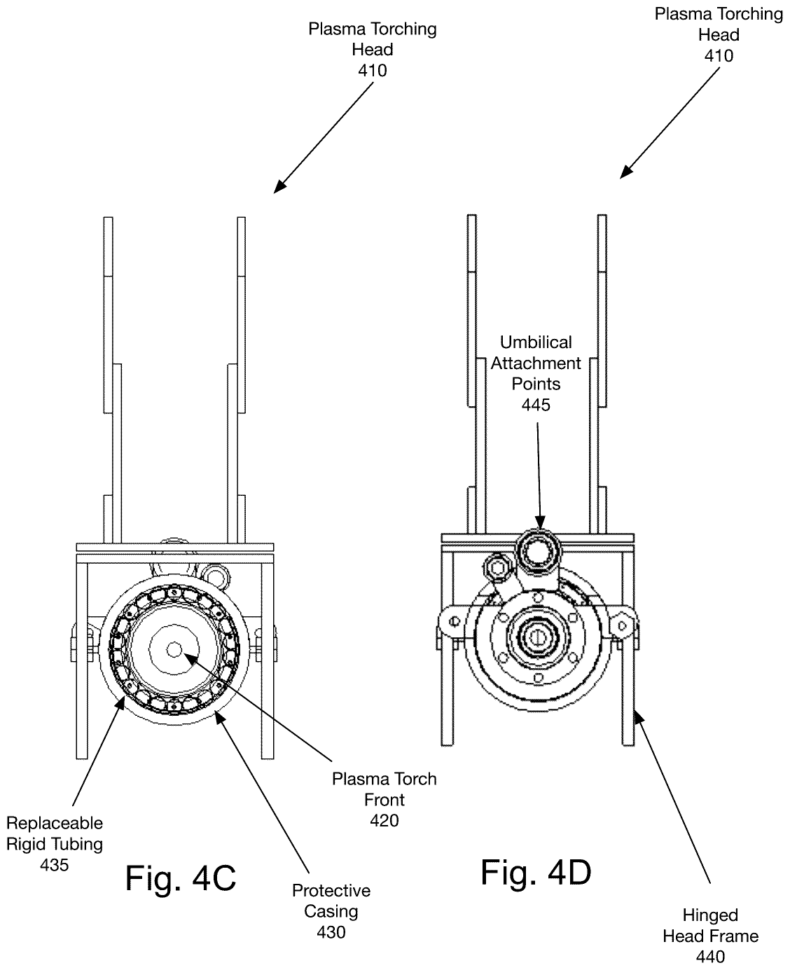

FIG. 4A is a perspective illustration of one embodiment of the plasma torching head and attachment mechanism. In this configuration, the plasma torching head 410 is supported by a hinged head frame 440, which is coupled to the attachment mechanism 415. The plasma torch includes a plasma torch head 420, and umbilical attachment points 445, to provide power. In the illustrated embodiment, the plasma torch is protected by protective casing 430. In one embodiment, additionally replaceable tubing 435 surrounds the entire plasma torch head 420. As discussed above, in some embodiments, the replaceable tubing may extend only along a portion of the plasma torch head 420. In another embodiment, the tubing may be eliminated. In one embodiment, the hinged head frame 440 enables the plasma torch to be tilted, providing further movement around the X-axis.

FIG. 4B is a side view illustration of one embodiment of the plasma torching head and attachment mechanism of FIG. 4A. The protective casing 430 is transparent to show the replaceable tubing 435 within the casing. The umbilical attachment points 445 are shown in more detail, showing separate connections for power, air, water, and control signals. FIG. 4C is a front view illustration of the plasma torching head and attachment mechanism of FIG. 4A, and FIG. 4D is a back view illustration of one embodiment of the plasma torching head and attachment mechanism of FIG. 4A. The specific embodiment shown is not intended to be limiting, and the configuration of the specific components may be altered without departing from the present invention.

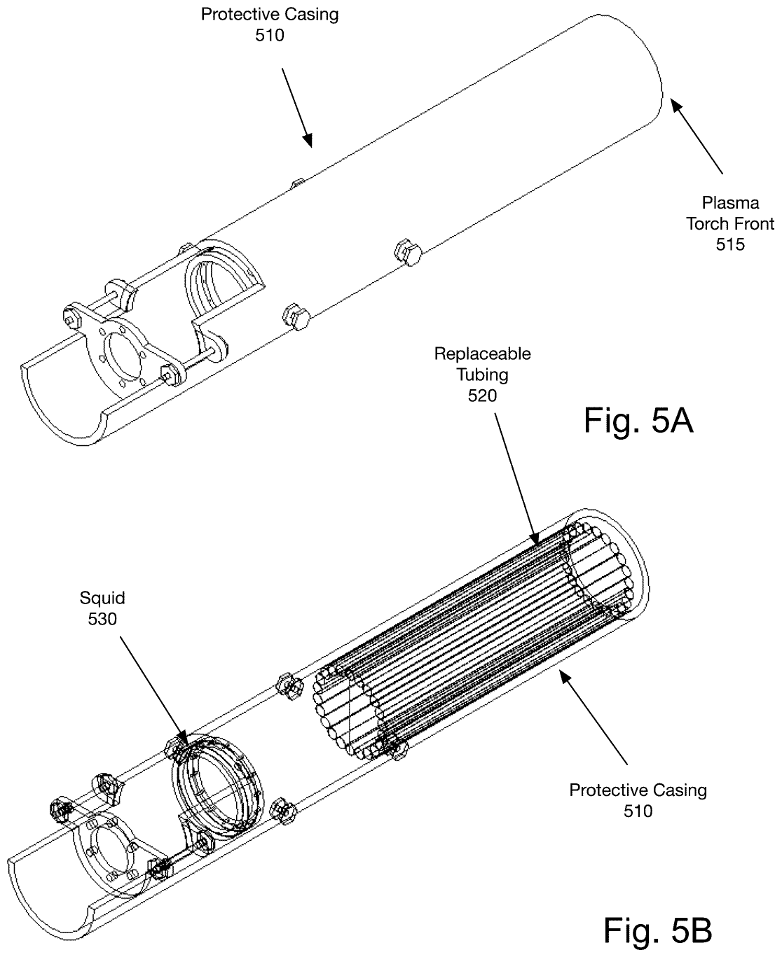

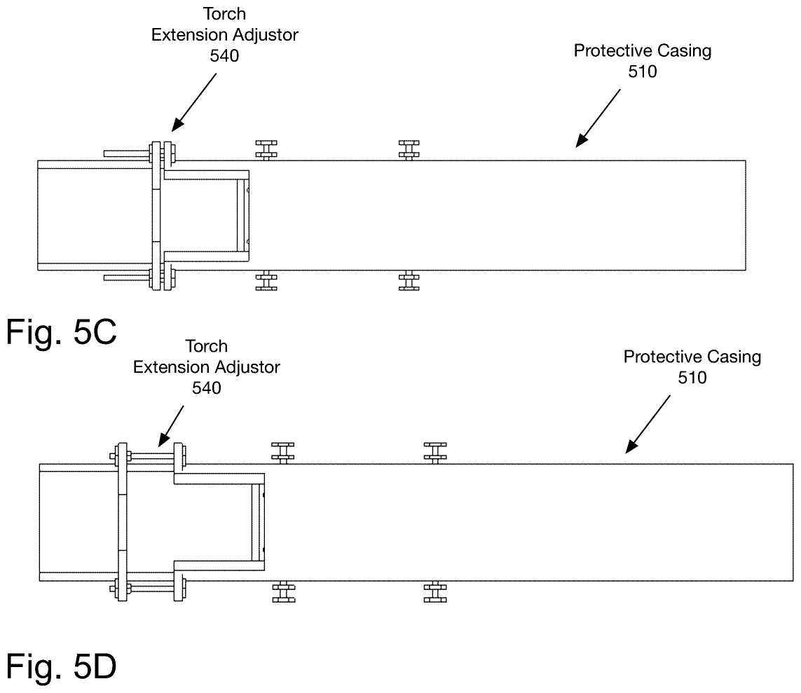

FIG. 5A is an illustration of one embodiment of the protective casing for the plasma torch, while FIG. 5B is an illustration of the interior of protective casing of FIG. 5A, with the casing shown as transparent. The protective casing provides an enclosure, which one embodiment is made of a heat resistant metal. The protective casing also provides structure for the air/water control 530, which sprays cold water and/or air onto the torch/material interface, to cool the material being removed and improve effectiveness of the plasma torch in breaking up the material.

FIGS. 5C-5D illustrate one embodiment of the torch extension adjuster. The protective casing 510 includes an adjustment mechanism which can move the plasma torches within the protective casing. In one embodiment, this adjustment mechanism is the torch extension adjustor 540, comprising dual screws on either side of the protective casing 610. In one embodiment the torch extension adjustor 540 is adjusted manually. In another embodiment, the torch extension adjustor 540 may be adjusted automatically, using an actuator (not shown).

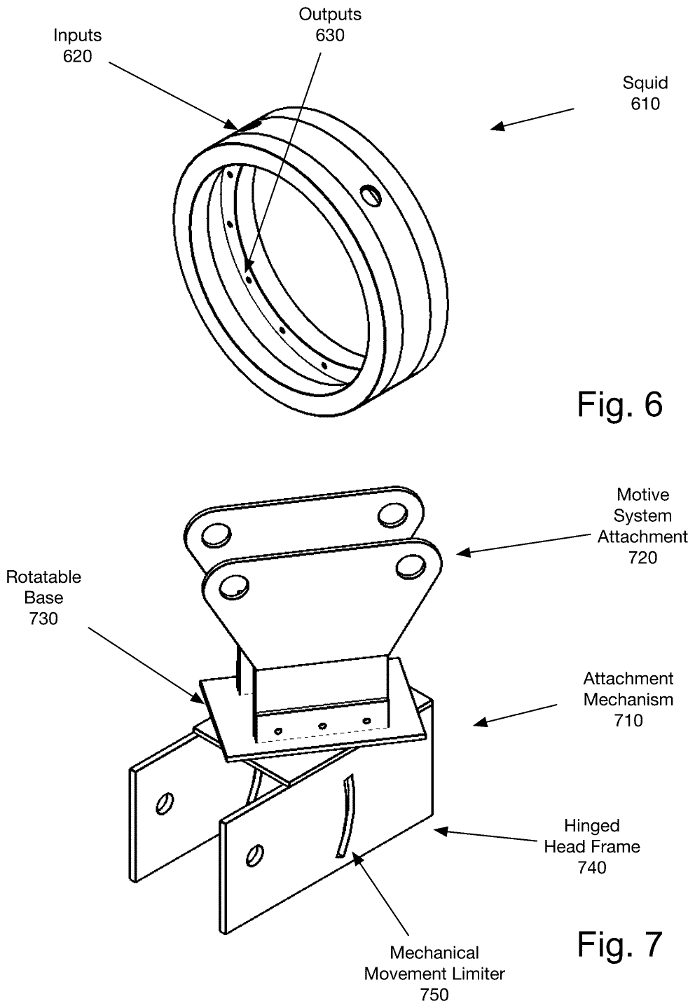

FIG. 6 is an illustration of one embodiment of the squid. The squid 610 includes inputs 620 and outputs 630. The inputs in one embodiment receive air and/or water from an umbilical coupled to the plasma torching head. The outputs are designed to output water/air onto the plasma plume/material interface. In one embodiment, the air/water provided at the inputs is cooled. In one embodiment, the outputs 630 include valves to pulse the air/water. In another embodiment, the controls for the air/water within the umbilical providing the air/water is used to control the intermittent pulsing of the materials.

FIG. 7 is an illustration of one embodiment of the attachment mechanism. The attachment mechanism 710 includes in one embodiment a motive system attachment 720, which is coupled to the mechanical arm. The mechanical arm attachment in one embodiment has a rotatable base 730, enabling rotation of the hinged head frame 740 around the Y-axis. The hinged head frame 740 supports the plasma torching head (not shown). Additionally, a mechanical movement limiter 750 permits rotation of the plasma torching head around the X-axis, while limiting the movement to ensure that the plasma plume will not intersect with the support structure.

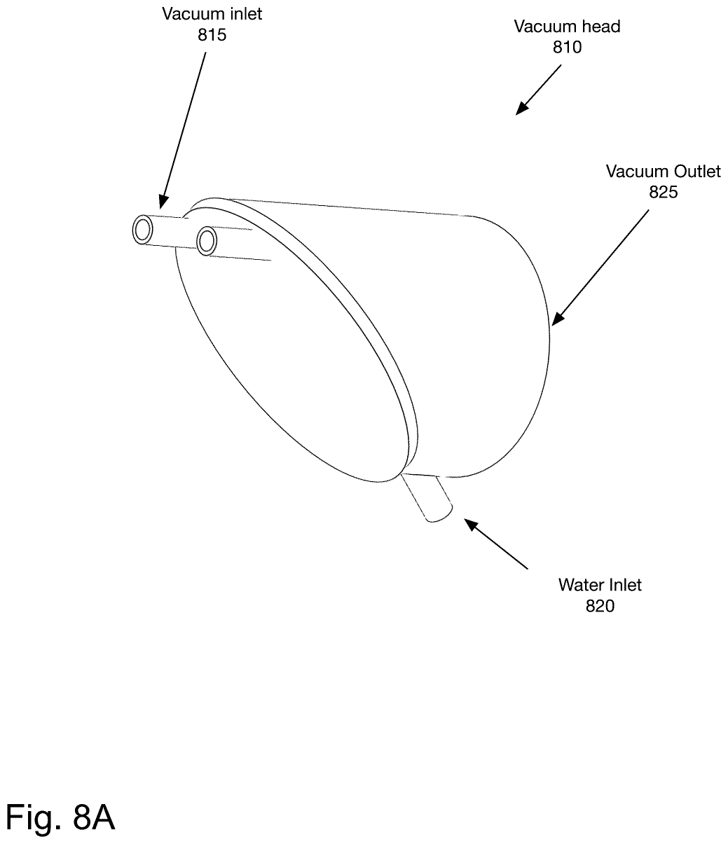

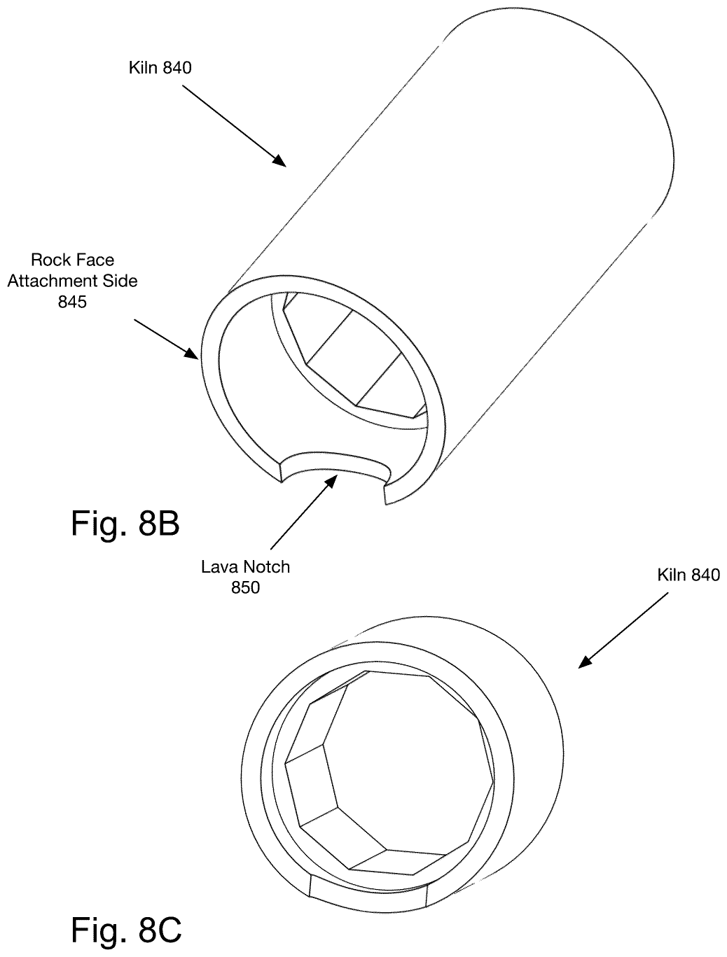

FIG. 8A is an illustration of one embodiment of a vacuum head which may be used with the present system. The vacuum head 810 in one embodiment is coupled to the front of the structure supporting the plasma torching head to remove the spoils. In one embodiment, the vacuum head is located immediately below the torch, to remove the debris closest to the torch. In some embodiments, there may be additional vacuum inlets and vacuum heads in the system.

The spoils in one embodiment may be liquid (lava), small rocks, and sand-like material. The vacuum head 810 is powered through an umbilical and pulls in the spoils. In one embodiment, the spoils are cooled within the vacuum head 810, and then passed to vacuum outlet 825, to be passed through an umbilical connection. In one embodiment, the materials in the vacuum head 810 are rapidly agitated to form a continuous stream of spoils. In one embodiment, the material is swirled while it is cooled. In one embodiment, the cooling and agitation is done using water. Water inlet 820 is where water is injected into the nozzle cooling the lava suctioned into the vacuum head 810.

In one embodiment, the byproducts or spoils of the process removed by the vacuum system may be used for the trenching or tunneling application, or for other applications. In one embodiment, because the spoils are rapidly cooled while being agitated, they form sharp sand, which is useful in construction.

FIGS. 8B-8C are an illustration of one embodiment of a kiln which may be used with the present system. The kiln 840 in one embodiment is used to focus energy when the plasma torch is initially turned on, before there is a hole in the rock face which constrains the plasma plume. In one embodiment, the kiln 840 is made of a thermally insulating material with a refractive interior, to focus the energy from the plasma plume. In one embodiment, the kiln 840 has a rock face attachment side 845, which is attached to the rock face. In one embodiment, the attachment may be by pressure (e.g., the plasma torching head holding the kiln by pressure), by glue, or by other means. In one embodiment, the kiln includes a notch 850 through which the spoils including lava (molten rock) can escape. In one embodiment, the kiln is used only until there is an initial hole in the rock. Once the initial hole is created, the kiln can be removed.

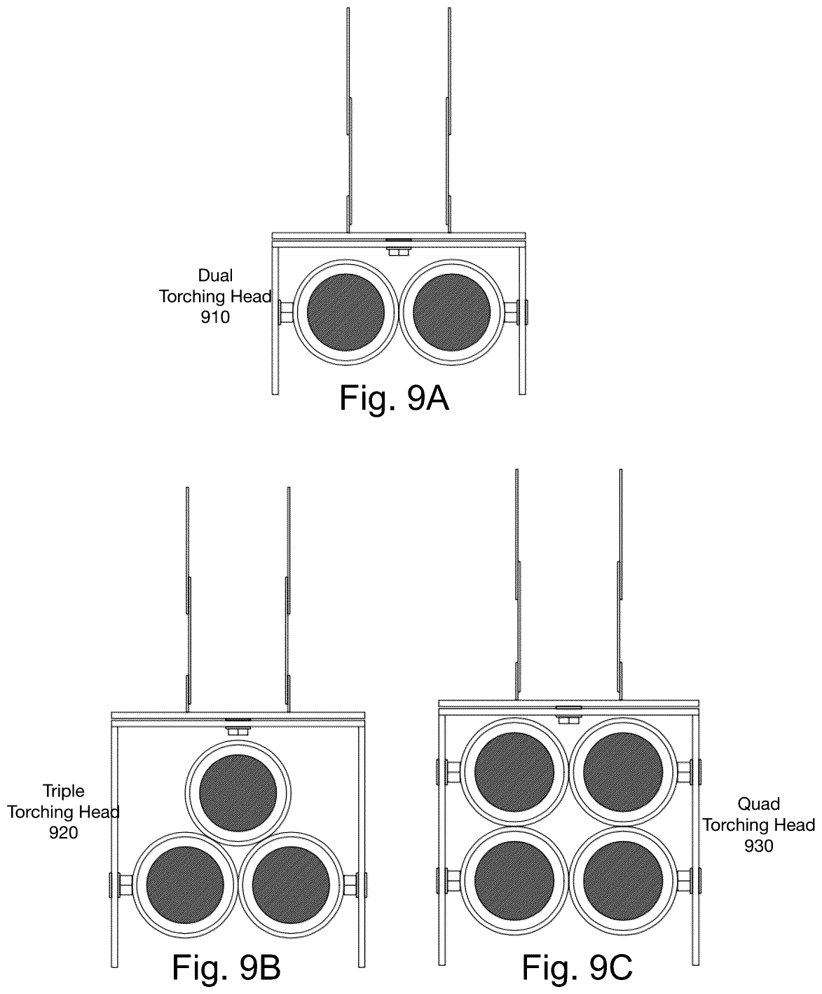

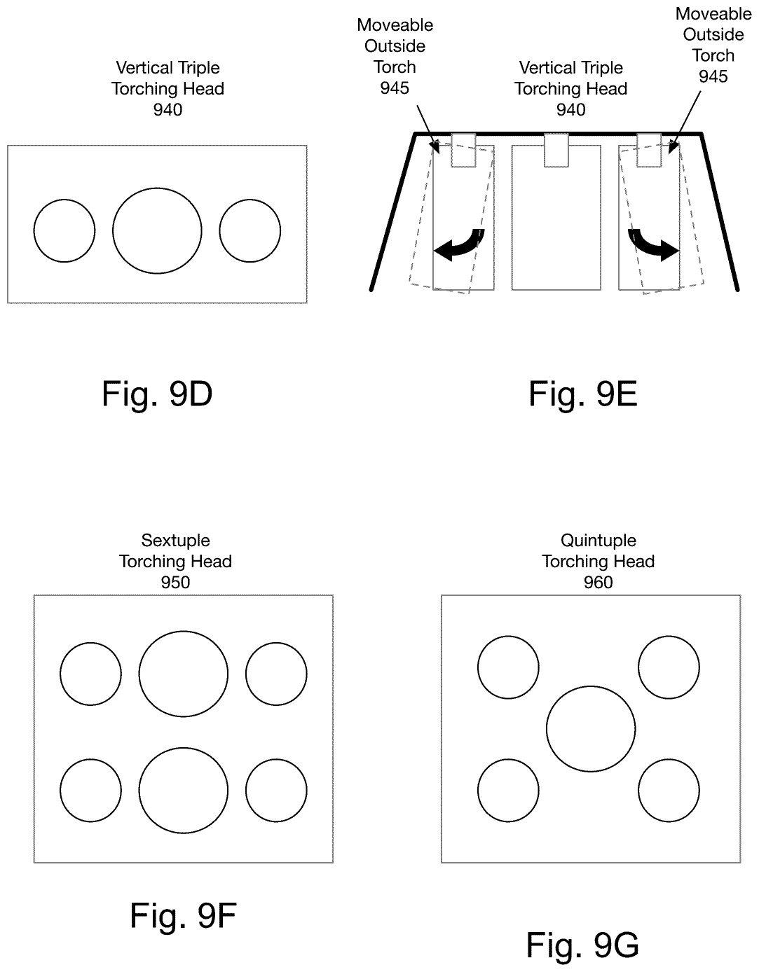

FIGS. 9A-9C illustrate embodiments of the plasma torching head, showing various numbers of torches. FIG. 9A illustrates a dual torching head 910 in which two plasma torches are side-by-side. In addition to a horizontal dual torching head, in some embodiments, the system may use a vertical dual torching head in which the two plasma torches are placed on top of each other. FIG. 9B illustrates a triple torching head 920, while FIG. 9C illustrates a quad torching head 930. Other arrangements of two or more torch heads may be used.

FIG. 9D is a diagram of one embodiment of a torch arrangement for a vertical triple torching head. The vertical triple torching head 940 includes three torch heads, with a larger torch head in the center, and two smaller torch heads of either side. The size of the torch heads, in this illustration, reflects the power output by the torch head. Thus, in this configuration, the center torch is higher powered than the two side torches. This configuration may be useful to bore a trench which is deeper in the center than at the sides, in one embodiment.

FIG. 9E is a side view of the diagram of FIG. 9D, showing moveable outside torches. In one embodiment, the outside torches may be rotated around the X-axis, such that the output of the moveable outside torches 945 extend at an angle. This enables the vertical triple torching head 940 to cut a wider trench than the width of the torch head 940.

FIGS. 9F-9G are diagrams of two exemplary multiple torch arrangements, with differing torch sizes. The exemplary sizes may be varied, depending on use. In one embodiment, the quick clamp configuration of the torching head allows the placement of different sizes of plasma torches, to optimize for the type of trench, tunnel, or other structure being created.

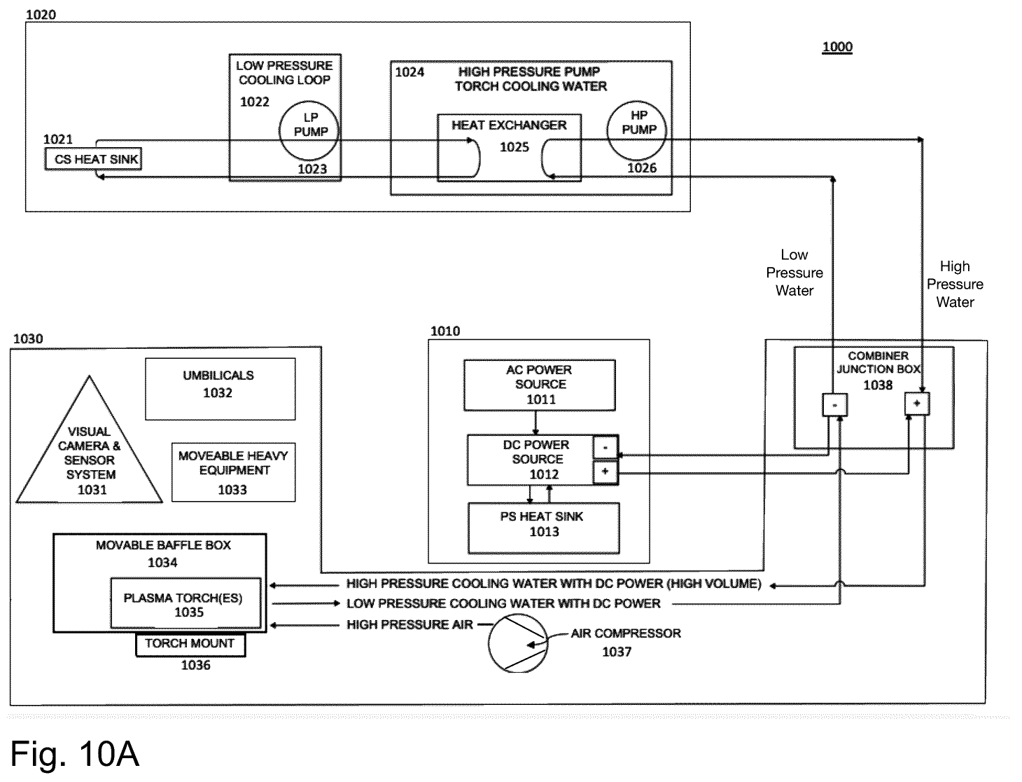

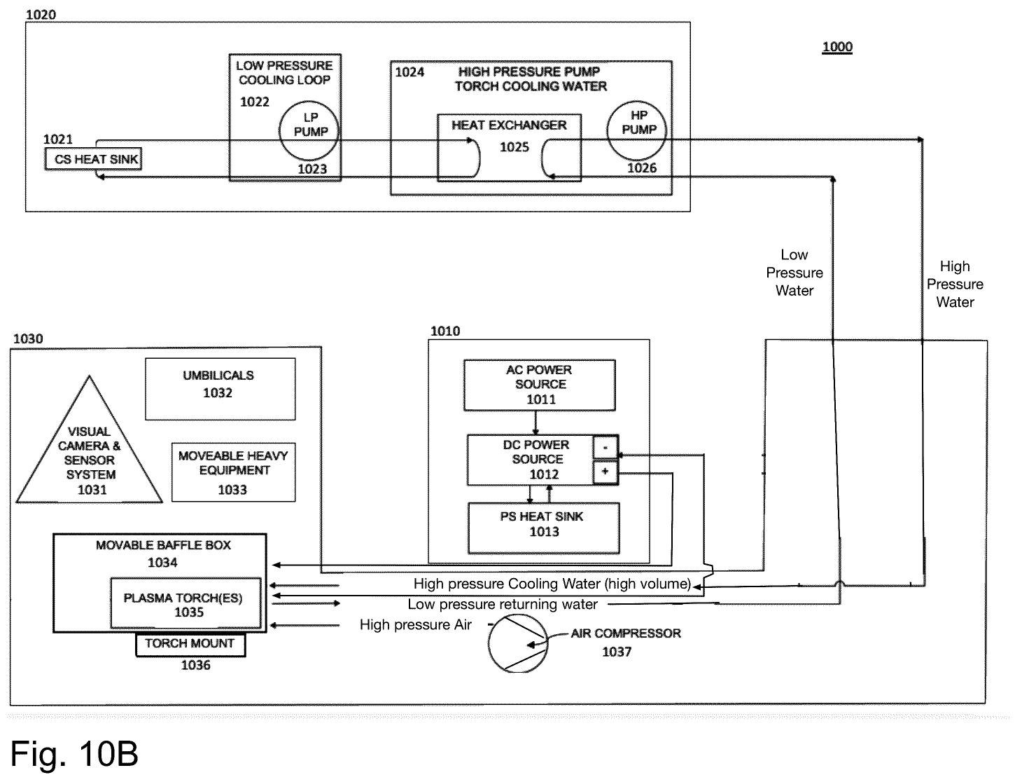

FIG. 10A is a diagram showing one embodiment of the connections of the system. In one embodiment, the system includes:

### Power Supply System 1010

i. 1011 AC Power Source
ii. 1012 DC Power Source
iii. 1013 Power System (PS) Heat Sink

### Water Supply System 1020

i. 1021 Cooling System (CS) Heat Sink
ii. 1022 Low Pressure Cooling Loop
iii. 1023 Low Pressure (LP) Pump
iv. 1024 High Pressure Pump Torch Cooling Water
v. 1025 Heat Exchanger
vi. 1026 High Pressure (HP) Pump

### Torch System 1030

i. 1031 Visual Camera & Sensor System (340)
ii. 1032 Umbilicals (325)
iii. 1033 Moveable Heavy Equipment (310)
iv. 1034 Movable Baffle Box (337) having a Protective Casing (335)
v. 1035 Plasma Torch(es) (345) having a Head (330)
vi. 1036 Torch Mount having Controllable Arm (315) with a Rotating Hinged Attachment (320)
vii. 1037 Air Compressor
viii. 1038 Combiner Junction Box (optional to allow separation of water and power)

FIG. 10B illustrates an alternative embodiment in which the combiner junction box 1038 has been removed, and the water and power are directed to the plasma torches 1035. In this configuration, the water and power interfaces are combined at the torches 1035, eliminating the need for a junction box.

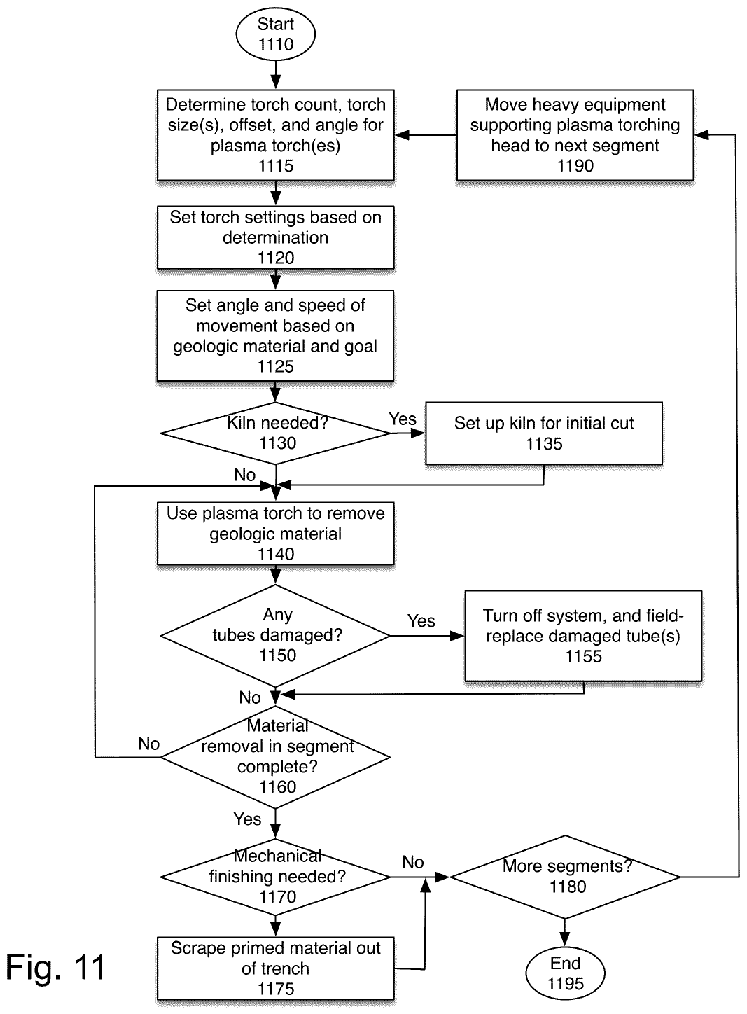

FIG. 11 is a flowchart of one embodiment of using the plasma torch system. In one embodiment, the present system may be used for boring a tunnel, trenching, excavation, or other uses in which a plasma torch moves through earth, rock, ground, or other material. The process starts at block 1110.

At block 1115, the number, size(s), offset(s), and angle(s) for the plasma torches is determined. The determination in one embodiment depends on the shape and position of the material to be removed, and the geologic material the plasma torches will be removing. In one embodiment, the torch size depends on the size and shape of the materials to be removed, and in a multi-torch torch head, the relative sizes of the torches are also determined. The offset is the distance between the front of the plasma torch and the geologic material. The angle determines the angle of the torching head, and thus the plasma torches. In one embodiment, for trenching, the initial angle may be 90 degree angle with respect to the geologic material that will be removed for the trench—that is the plasma torches are vertical.

At block 1120, the torch settings are set based on the determination.

At block 1125, the angle and speed of movement are selected based on the material to be removed, and the size of the intended area. In one embodiment, the number of passes to dig the trench is also taken into account.

At block 1130, the process determines whether a kiln is needed. The kiln is used optionally to focus the energy during the first phase of the boring into the rock, before there is a cavity created in the rock material. If a kiln is used, at block 1135, the kiln is set up. Setting up the kiln, in one embodiment includes placing the kiln on the rock face where the drilling will start. The process then continues to block 1140. If no kiln is going to be used, the process continues directly to block 1140.

At block 1140, the plasma torch is used to remove material. In one embodiment, the plasma torch is moved back and forth. In one embodiment, the speed of movement depends on the composition of the geologic material being removed and the power of the plasma torch(es). In one embodiment, the plasma torch remains in one place and is only moved once the material at the current position is successfully removed.

At block 1150, the process optionally determines whether any sacrificial tubes are damaged. In one configuration the plasma torching head is surrounded by sacrificial tubes which may be easily replaced if damaged. In one embodiment, this determination is made by manual inspection. In another embodiment, a camera is used to monitor the shape and configuration of the sacrificial tubes, and the system determines automatically if there is a deviation from the expected configuration, indicating damage. If any of the tubes are damaged, as determined at block 1150, the process continues to block 1155. At block 1155, the system is turned off and the damaged tubes are field replaced.

At block 1160, the process determines whether the current portion of the removal has been finished. If not, the process continues to block 1140 to continue removing the material. Otherwise, the process continues to block 1170.

At block 1170, the process determines whether mechanical finishing is needed. Mechanical finishing applies mechanical force in addition to or subsequent to the application of the plasma torch, to remove the remaining material. If so, at block 1175, the primed material made more friable by the plasma torch is removed using mechanical means. The mechanical means may be using an excavator head, a scraper, a hammer, or another mechanism to remove material. The process then continues to block 1180.

At block 1180, the process determines whether there are more segments to remove. If so, the process continues to block 1190. At block 1190, the equipment supporting the plasma torching head is moved to the next location. The process then continues to block 1115, to evaluate the torch size. In one embodiment, if no change in the material being removed is detected, the process instead continues from block 1190 to block 1140, to start removing material at the new location, because other settings do not need to be changed. If no more portions should be removed the process ends at block 1195.

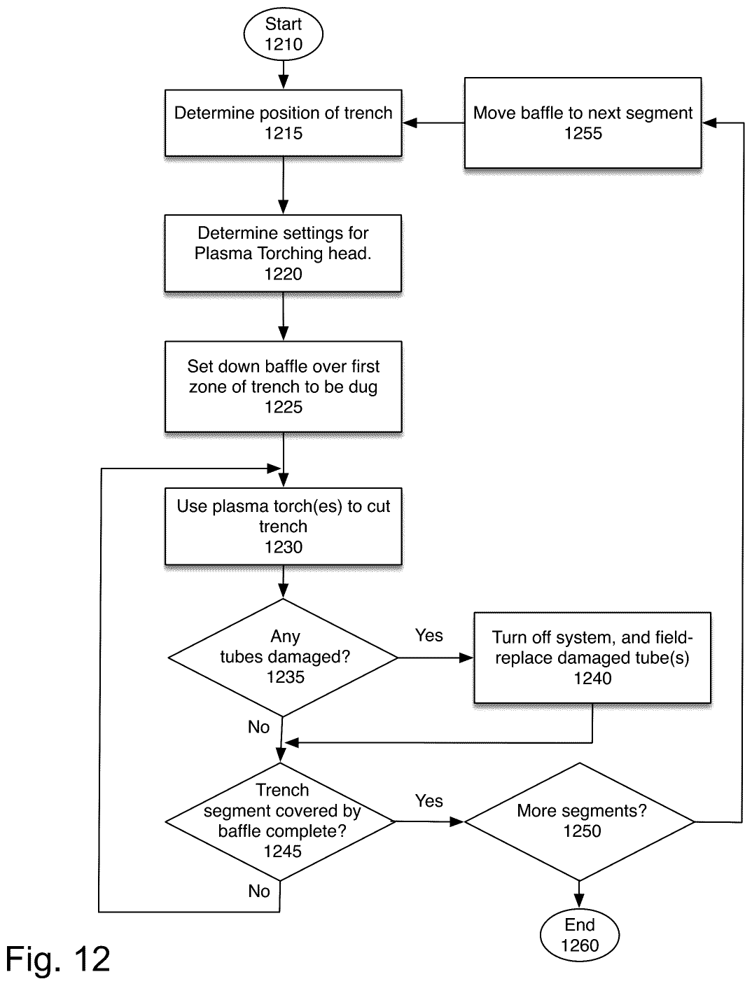

FIG. 12 is a flowchart of one embodiment of using the plasma torch system with a moveable baffle to create a trench. The process starts at block 1210.

At block 1215, the position for the trench is determined.

At block 1220, the configuration of the plasma torching head is determined. The configuration includes in one embodiment the size and position of the plasma torches, as well as the offset.

At block 1225, the baffle is positioned over a first zone of the trench to be dug. In one embodiment, the baffle is positioned along the trench, so the longest dimension of the baffle corresponds to the length of the segment of trench that can be completed without moving the baffle.

At block 1230, the plasma torches are used to cut the trench within the baffle.

At block 1235, the process determines whether any tubes are damaged if the configuration includes tubes. If so, at block 1240, those tubes can be field replaced.

At block 1245, the process determines whether the portion of the trench covered by the baffle has been completed. If not, the process returns to block 1230, to continue using the plasma torches to cut the trench. If so, the process continues to block 1250.

At block 1250, the process determines whether there are more segments to cut. If not, the process ends at block 1260. If there are more segments, the process continues to block 1255, and the baffle is moved to the next segment. The process then continues to block 1215.

Of course, although these processes are shown as flowcharts, in one embodiment the order of operations is not constrained to the order illustrated, unless the processes are dependent on each other. Furthermore, decisions may be implemented using an interrupt-driven system, and thus the system does not check for the occurrence, but rather the occurrence sends a notification to trigger actions. Additionally, some or all of the steps shown may be skipped in some embodiments.

The above examples of the configurations of the plasma torching system are described in separate embodiments. However, one of skill in the art would understand that the various embodiments may be combined. For example, the various plasma torching head configurations may be used with the various baffle configurations. The camera/sensor bar may be incorporated into systems not using an excavator, the number of plasma torches may be varied with the different plasma torching heads, etc.

In the foregoing specification, the geologic material removal system has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative rather than a restrictive sense.

We claim:

1. A geologic material removal system comprising:
a moveable support structure including a controller;
a mechanical arm;
an attachment mechanism removably coupled to the mechanical arm;
a plasma torching head coupled to the attachment mechanism, the plasma torching head supporting a plasma torch for removing geologic material, the plasma torching head moveable along two axes.

2. The geologic material removal system of claim 1, wherein the moveable support structure is an excavator.

3. The geologic material removal system of claim 1, wherein the plasma torching head comprises a plurality of plasma torches.

4. The geologic material removal system of claim 3, wherein the plurality of plasma torches are different sizes.

5. The geologic material removal system of claim 1, further comprising:
a plurality of sensors coupled to the geologic material removal; and
a controller to determine a quality of earth being removed and adjust one or more settings of the plasma torching head.

6. The geologic material removal system of claim 1, wherein the plasma torching head comprises:
a protective casing surrounding a plasma torch; and
a plurality of field replaceable tubes around a portion of the plasma torch configured to absorb impact to protect the plasma torch.

7. The geologic material removal system of claim 1, wherein the plasma torching head comprises:
a carriage moveably coupled to rails;
a plasma torch coupled to the carriage; and
an actuator to move the carriage to position the plasma torch for trenching.

8. The geologic material removal system of claim 7, further comprising:
a shield at a front of the plasma torching head, the shield including a hole through which the plasma torch extends.

9. The geologic material removal system of claim 1, further comprising:
a baffle to enclose the plasma torching head, the baffle configured to control dispersion of spoils during use of the geologic material removal system.

10. The geologic material removal system of claim 9, further comprising:
the attachment mechanism coupled to the baffle;
a head support configured to moveably support the plasma torching head; and
rails along which the head support moves, to reposition the plasma torching head, such that a plasma torch moves while the baffle is stationary.

11. The geologic material removal system of claim 9, wherein the baffle includes a dispersal slot, through which the spoils can exit the baffle.

12. The geologic material removal system of claim 9, wherein the moveable support structure comprises an excavator.

13. The geologic material removal system of claim 1, further comprising:
a squid to provide cooling to a surface being cut by a plasma torch, wherein the cooling comprises one or more of air and water.

14. The geologic material removal system of claim 1, further comprising:
a vacuum head to vacuum up spoils generated by a plasma torch, the vacuum head including a water inlet to cool the spoils before the spoils enter a vacuum hose.

15. The geologic material removal system of claim 1, further comprising:
a kiln comprising a tube of refractive material placed in front of a plasma torch, the kiln configured to constrain a plasma plume when an initial bore hole is made.

16. A geologic material removal system comprising:
a moveable support structure including a trenching controller;
a plasma torching head configured to cut a trench;
a baffle to enclose the plasma torching head, the baffle providing protection for spoils from the plasma torching head.

17. A geologic material removal system comprising:
an attachment mechanism to moveably couple a plasma torching head to a moveable support structure;
a plasma torch in a protective casing; and
replaceable tubing around at least a portion of the plasma torch and extending beyond an electrode of the plasma torch, such that a plasma plume produced by the plasma torch extends beyond the tubes, the tubes providing protection for the plasma torch.

18. The geologic material removal system of claim 17, further comprising:
a squid to direct a cooled stream to cool a surface being trenched.

19. The geologic material removal system of claim 17, further comprising:
a control system to adjust a horizontal travel rate and depth of the plasma torch, based on a size of a trench and geologic material being removed.

20. The geologic material removal system of claim 17, further comprising:
a baffle surrounding the plasma torching head, the baffle to control dispersion of spoils from the removal.
